(19) United States
(12) Patent Application Publication
(10) Pub. No.: US 2007/0077409 A1
(43) Pub. Date: Apr. 5, 2007

(54) Porous substrate with smooth surface and production method thereof

(75) Inventors: Takayuki Hirano, Kobe-shi (JP); Nobuyuki Kawakami, Kobe-shi (JP); Takeharu Tanaka, Kobe-shi (JP); Tetsuo Suzuki, Kobe-shi (JP); Yoshito Fukumoto, Kobe-shi (JP); Kazuki Nakanishi, Kyoto-shi (JP); Kazuyoshi Kanamori, Kyoto-shi (JP)

Correspondence Address: REED SMITH HAZEL & THOMAS, Suite 1400, 3110 Fairview Park Drive, McLean, VA, 22042, US

(73) Assignees: Kabushiki Kaisha Kobe Seiko Sho; Kyoto University

(21) Appl. No.: 11/520,738

(22) Filed: Sep. 14, 2006

(30) Foreign Application Priority Data
Sep. 30, 2005 (JP) 2005-289250

(51) Int. Cl. B01J 13/00; B32B 3/26; B01D 21/01; C08J 3/02; C09K 3/00

(52) U.S. Cl. 428/312.6; 428/304.4; 516/98

(57) ABSTRACT

The porous substrate, comprises: three-dimensional-network skeletal solid phase inside the substrate, and a skin layer same in quality as the skeletal solid phase formed on at least one surface of the substrate, and a production method thereof, comprising: forming a wet gel having a three-dimensional-network skeletal solid phase and a fluid phase rich in solvent that are separated from each other in a space between a pair of flat plates by sol-gel reaction, removing the solvent in the wet gel by drying, and removing at least one flat plate of the pair of flat plates.

### BACKGROUND OF THE INVENTION

1. Field of the Invention

The present invention relates to a substrate of an inorganic porous material and a method of producing the same, and the substrate can be used effectively, for example, as an insulative substrate lower in dielectric loss in the high-frequency region.

2. Description of the Related Art

Recently, there is a demand for low-dielectric interlayer insulation films having a dielectric constant of 2 or less for an interlayer insulation film of semiconductor devices, and use of a porous material lower in density was proposed as a raw material for such a film. There is also a need for higher-frequency operation of electric circuits for mounting elements and also of dielectric substrates and laminated substrates for antennas; and, in such a case, a porous insulative film and a porous dielectric film are required from the viewpoint of reduction of dielectric constant and also dielectric loss.

Also in the fields of electric and electronic parts for sensor and reaction cells for chemical reaction, there is a need for materials larger in specific surface area, lower in density and thermal conductivity, and porous films satisfying these requirements have received attention as an insulative or dielectric film.

The porous films used as a substrate for the electric and electronic parts in these various applications are usually prepared from an inorganic material stable chemically, physically and thermally, such as silica-based material. The thickness of the porous film is preferably adjustable in thickness according to desired properties and functions of the substrate. For example, a dielectric film for use as a low-loss substrate effective in the millimeter wave region of over 25 GHz preferably has a thickness of approximately 100 μm.

For example when spin coating is used in forming the porous film, the thickness of the porous film obtained depends mostly on the viscosity of the raw material solution and the rotation frequency of spin coating, and thus, it is difficult to prepare a film having a favorable thickness, especially when a thicker film is desired.

A mixed solution containing water, an acid catalyst, a surfactant, and others is often used as a raw material solution for hydrolysis, for example, of a metal alkoxide in sol-gel reaction, but, because the blending ratio should be adjusted mainly for construction of the structure of the porous film as described, for example, in Patent Document 1, it is not always possible to adjust the mixed solution to viscosity optimal for giving a film with a desired thickness in the coating step, often resulting in a viscosity of the raw material solution far lower than that desired. In such a case, the thickness of the porous film is restricted to approximately 1 μm at most, and it is difficult to obtain a thick porous film by spin-coating.

The method disclosed in Patent Document 2, in which the solid component is separated from the solvent and dried and solidified immediately after application, is effective in forming a relatively thin film, but causes problems, such as cracking and fracture of the film by shrinkage during drying, in production of a thick-walled porous film. In addition, porous materials formed by sol-gel process in an open space and plate materials cut off from a bulky porous material, which have a number of pores and convexoconcaves on the surface of the porous material, make it difficult to form a thin-film circuit or wiring on the surface thereof.

Patent Document 3 discloses a micro strip substrate by using a porous material. However, the production method therein contains no description on the surface state of the substrate on its circuit-forming side; the production process is essentially the same as that for a bulk material by using a container in the open system; and there is also no consideration about uniformity in thickness needed as a thin-film dielectric material.

Patent Document 4 discloses a film-of porous material of polyimide, but it still does not satisfy requirements in heat resistance and mechanical properties.
Patent Document 1: Japanese Patent Application Laid-Open No. H11-292528
Patent Document 2: Japanese Patent Application Laid-Open No. 2005-780
Patent Document 3: Japanese Patent Application Laid-Open No. H8-228105
Patent Document 4: Japanese Patent Application Laid-Open No. 2003-201363

### BRIEF SUMMARY OF THE INVENTION

An object of the present invention, which was made under the circumstance above, is to provide a uniform porous plate (film) having a desired thickness and a smooth surface that does not generate cracking or separation as a porous substrate for use as a dielectric material, and a method of producing such a porous substrate.

The porous substrate of the present invention comprises: three-dimensional-network skeletal solid phase inside the substrate, and a skin layer same in quality as the skeletal solid phase formed on at least one surface of the substrate.

The porous substrate of the present invention is produced by a method, comprising:

forming a wet gel having a three-dimensional-network skeletal solid phase and a fluid phase rich in solvent that are separated from each other in a space between a pair of flat plates by sol-gel reaction,

removing the solvent in the wet gel by drying, and

removing at least one flat plate of the pair of flat plates.

### BRIEF DESCRIPTION OF THE DRAWINGS

FIG. 1 is a schematic cross-sectional view illustrating an embodiment of the present invention.

FIG. 2 is a SEM micrograph showing the surface side of the porous dielectric substrate prepared in the embodiment above.

FIG. 3 is a schematic cross-sectional view illustrating another embodiment of the present invention.

### DETAILED DESCRIPTION OF THE INVENTION

The porous substrate of the present invention is the one produced by sol-gel reaction, and characterized in that a three-dimensional-network skeletal solid phase is formed inside the substrate and a skin layer same in quality as the skeletal solid phase is formed on at least one surface of the substrate.

The thickness of the porous substrate is preferably 10 μm or more and 1,000 μm or less as a total thickness of the skeletal layer and the skin layer; and the skin layer is formed continuously on the entire surface of the porous substrate, and the thickness of the skin layer is particularly preferably 10 nm or more and 1 μm or less. The porous substrate having a skeletal solid phase made of a mainly silica-containing material is extremely useful as a substrate material for wiring that is used in a high-frequency region over 10 GHz.

The production method according to the present invention, which is an invention considered to be useful in production of the porous dielectric substrate in the configuration above, comprises a step of forming a wet gel having a three-dimensional-network skeletal solid phase and a fluid phase rich in solvent that are separated from each other by sol-gel reaction in a space between a pair of flat plates, a step of removing the solvent in the wet gel by drying (volatilizing), and a step of removing at least one flat plate of the pair of flat plates in contact with the wet gel.

In the production method, the wet gel is preferably enclosed in the space formed by the pair of flat plates in contact with surfaces facing each other between the pair of flat plates, and at least part of the flat plate to be removed is preferably constituted by a plate easily separable from the skin film on the skeletal solid phase formed on the surface of the flat plate. A plate constituted by a metal plate or a metal layer in part of the face in contact with the wet gel may be used as at least one of the flat plates; and it is possible to prepare a substrate having a porous layer tightly bound and integrated on one flat plate when a thin film of a mainly silicon-containing material is formed on the surface of the metal plate or the plate having a metal layer on at least part of the surface.

The raw material for the three-dimensional-network skeletal solid phase is a sol-gel reactive mixed solution, which contains at least a metal alkoxide and water, and additionally one or both of a catalyst and a solvent. In particular, the porous substrate prepared from a mixed solution containing a methyl group-containing silicon alkoxide as metal alkoxide in which the skeletal solid phase is mainly made of silica is preferable, as it becomes a porous dielectric substrate having a smaller transmission loss.

The pair of flat plates is preferably placed in parallel with each other, and the surface of at least one of them, or an “easily separable plate”, preferably has a hydrophobic surface constituted by carbon or a hydrocarbon resin or a fluororesin as a principal component or by at least one metal selected from Al, Cu and noble metals as a principal component.

### EFFECT OF THE INVENTION

According to the present invention, a porous substrate superior in surface smoothness and uniformity can be obtained. In particular, it is possible to prepare a substrate having a desired thickness by adjusting the space distance between the pair of flat plates, for example, with a spacer. In addition, because a uniform skin layer is formed in sol-gel reaction on the surface of the flat plate where the substrate is formed, it is possible to form a thin-film electric or electronic circuit on the surface easily and to provide a high-quality porous substrate lower in transmission loss.

### BEST MODE FOR CARRYING OUT THE INVENTION

In the present invention, for example, a member for forming a porous material having a dielectric property, preferably a pair of flat plates is placed at an arbitrary distance, preferably parallel to each other. A wet gel in which a skeletal phase (solid phase) having three-dimensional network and a fluid phase rich in solvent are separated from each other is formed in a space between the flat plates by sol-gel reaction. The wet gel is then enclosed in the space formed by the pair of flat plates in contact with each surface facing each other between the pair of flat plates.

A porous substrate is obtained by carrying out a step of drying the fluid phase (drying step) and a step of removing at least one flat plate of the pair of flat plates (flat plate-removing step) in arbitrary order.

The flat plate may be removed by dissolution, for example by etching. It is preferable that at least a part of the face which comes into contact with the porous substrate is constituted by an easily separable raw material because it is possible to expose the surface of porous substrate simply by removing the flat plate.

More specifically, when the surface of the flat plate is constituted by a hydrophobic face, such as a fluororesin or a hydrocarbon resin, it is possible to separate and remove the flat plate easily from the hardened wet gel or its dried film. Also when a plate material such as of Al, Cu, or a noble metal (specifically, Au, Pt, or the like) or a plate material having a metal layer formed or clad on the part of surface is used as a raw material for the flat plate, it is possible to separate and remove the flat plate from the hydrous gel or the dried gel easily, because the skeletal solid phase of the three-dimensionally hardened matrix product (gel) formed by sol-gel reaction in the space between the flat plates is less adhesive to the metal surface.

The raw material for the skeletal solid phase is favorably, for example, an alkoxide of silicon, Ti, Al, boron, or the like, especially the one containing silica mainly. For example, silicon alkoxide, such as methyltrimethoxysilane, methyltriethoxysilane, dimethyldimethoxysilane, dimethyldiethoxysilane, tetraethoxysilane, tetraisopropoxysilane, tetramethoxysilane, tetra-n-butoxysilane, triethoxysilane, or trimethoxysilane is recommended favorably as a raw material, because it forms a porous film chemically stable and lower in dielectric constant. The number of the alkyl groups bound to Si is preferably 2 or less, more preferably 1.

Among them, a methyl group-containing silicon alkoxide is preferable used in preparation of a porous substrate superior in hydrophobicity, crack resistance, and others. There are many alkyl group-containing siloxane polymers. Among them, methyl group-containing silicon alkoxides are particularly preferable in preparing a porous substrate lower in dielectric loss, because there is tendency that increase in the length of the hydrocarbon chain leads to increase in dielectric loss.

In the present invention, the dielectric constant of the porous substrate can be adjusted and controlled to approximately 1.2 to 2.0.

Known is a method of preparing a porous material by adding a surfactant to the raw material solution and removing the surfactant after reaction (for example, Mat. Res. Soc. Symp. Proc. Vol., 788 (2004), Materials Research Society L7.5.1 to 7.5.10) for increase in the porosity of the porous dielectric material and preparation of uniform pores; and the present invention is also applicable to the porous gels formed by such a method. Favorable examples of the surfactants include nonionic surfactants such as polyoxyethylene decyl ether, and polyoxyethylene lauryl ether, cationic surfactants such as tetradecanyltrimethylammonium chloride, and hexadecyltrimethylammonium chloride, and the like. Favorable solvents include methanol, ethanol, isopropanol, ethylene glycol, and the like.

Uniformity of thickness of the porous substrate depends on uniformity of a space formed by two flat plates facing each other. It is possible to prepare a uniform-thickness porous substrate, even having a larger area, by using a method of placing spacers at a suitable interval between the flat plates.

The face from which the flat plate is removed, i.e., the face on which, for example, a printed wiring circuit is formed when used as a dielectric substrate, may be one side or both sides of the dielectric substrate. When a metal face functioning as a ground electrode is formed on the dielectric substrate, the dielectric material may be formed on a metal plate from the beginning of production. Thus, only one or both of the pair of flat plates may be removed.

In such a case, when a thin film of a material easily reacting with and binding tightly to the skeletal solid phase of the gel formed by sol-gel reaction in the space between flat plates, for example, a silicon-based material or a thin metal film, such as titanium or chromium, functioning as an adhesion layer, is formed, it is possible to form a substrate with a porous dielectric film tightly bound and integrated on the metal plate. The material mainly containing silicon is preferably silicon oxide, and in addition, for example, silicon nitride may be used.

Components for the flat plate having a relatively higher adhesion force is selected properly, for example, by considering use as an electrode layer, adhesiveness with the dielectric layer, electrical characteristics (low resistance), and conditions in manufacturing process.

The surface of metal of the substrate or the thin film functioning as adhesion layer is preferably made of a material that is not dissolved by a catalyst (acid or alkali) and an organic solvent in the solution and is compatible with silica-containing compounds etc. forming the skeletal solid phase. Typical examples of such a material are metal oxides such as SiO₂; and transition metals on the surface of which a metal oxide is easily formed, such as titanium and chromium.

For example when a high-frequency circuit is formed, the ground electrode should also have low resistance, and thus, Cu or Ag, or the like is used as the metal. Al is also recommended as a low-resistance inexpensive raw metal material. However, similarly to the adhesion layer above, the metal plate should not be dissolved by catalysts (acid or alkali) and organic solvents in the solution, and thus, Al is preferable when nitric acid is used as a catalyst, and Cu is preferable when hydrochloric acid or other weak acid or alkali is used as a catalyst.

When the dielectric substrate is used as a sensor or other electronic element, single-crystal silicon, glass, or a resin, for example, may be used instead of the metal plate as a substrate material superior in strength and flatness and having a function as a ground electrode. When single-crystal silicon or glass is used, which easily binds to silica constituting the gel and is less soluble in catalyst, it is possible to make it adhere to the porous film sufficiently tightly even without forming an additional adhesion layer.

In preparation of the porous material to be used as a substrate, a metal alkoxide and water are used as essential starting materials. The reaction may be carried out in the absence of a catalyst or solvent, depending on reaction conditions (ultrasonication etc.). In catalytic reaction, the metal alkoxide is hydrolyzed in the catalytic reaction, followed by the sol-gel reaction to give a porous wet gel, and then dried, to give a porous substrate. The drying methods may be air drying, drying under heat. In addition, supercritical drying, drying after substitution with a solvent having a smaller capillary force, and the like may be exemplified for prevention of destruction of fine porous structure by capillary force during drying.

The pores in the porous material need to be exposed to external space during drying. Thus, the pair of flat plates and the spacer, which constitute a template for forming the dielectric substrate, preferably have a structure suitable for drying. Specifically, it is possible to raise efficiency of filling and drying the raw material solution in space when an opening to communicate between the inside and outside is formed in spacers.

The porous film formed by the method above has a three-dimensional-network skeletal solid phase formed inside in sol-gel reaction and also a skin layer having the same quality as the skeletal solid phase at the interface between the flat plate and the porous material. A continuous skin layer suitable for circuit formation is formed on the surface when the flat plate is separated from the wet gel or its dried gel. As such a continuous skin layer is formed on the surface as described above, it is possible to minimize the loss of wiring materials when, for example, a circuit is formed on the surface. The resistance of the wiring surface determines conductor loss, especially in a high-frequency region such as millimeter wave. Presence of a skin layer on the surface of porous film decreases conductor loss, allowing production of a dielectric substrate lower in transmission loss.

Thickness of the substrate according to the invention is not particularly limited, but preferably 10 μm or more and 1,000 μm or less, more preferably 50 μm or more and 500 μm or less, from the viewpoint of productivity and properties when the substrate is used, for example, as a dielectric substrate. Thickness of the skin layer formed on the substrate surface is preferably 10 nm or more and 1 μm or less from the viewpoint of strength and applicability as a dielectric substrate.

### EXAMPLES

Hereinafter, the present invention will be described more specifically with reference to Examples, but it should be understood that the present invention is not restricted by the following Examples, modifications can be made within the scope of the description above and below, and such modifications are also included in the technical scope of the present invention.

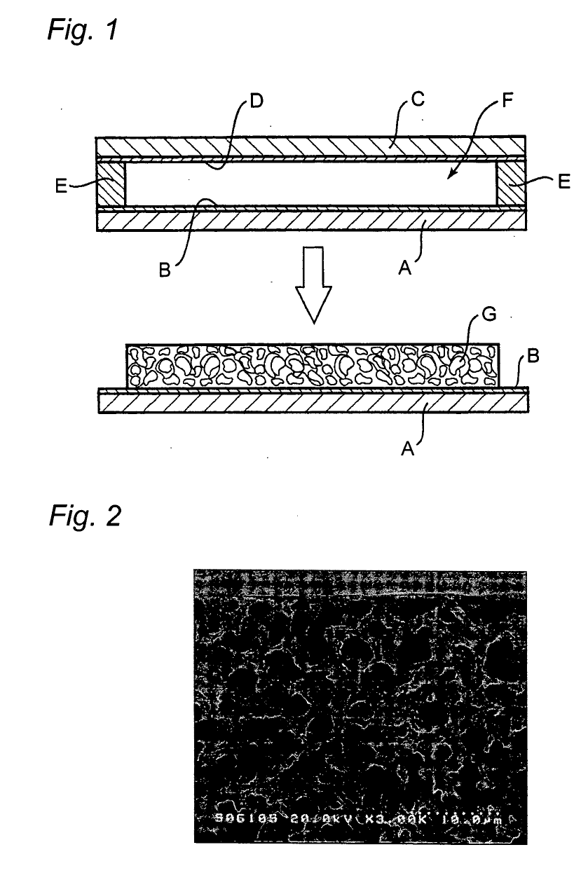

A first Example will be described with reference to FIG. 1.

FIG. 1 is a schematic cross-sectional view illustrating the method of producing a porous substrate useful as a dielectric material. A pure Al plate A is used as one of flat plates for forming a substrate, and a SiO₂ film B having a thickness of 0.5 μm is formed on the surface of the Al plate A, for example, by plasma CVD. A flat glass plate C with PTFE (polytetrafluoroethylene) tape D bonded thereto was used as the other flat plate. The two flat plates were placed facing each other; two PTFE spacers E having a thickness of 0.1 mm (100 μm) were placed between the flat plates at their ends, forming a space F in parallel with the plates; and openings for drying are formed respectively at the side face.

A raw material solution for the porous substrate was prepared in the following manner: 2.6 ml of aqueous 1M nitric acid solution and 2.8 ml of methanol were measured and put into a sample bottle, and 10 ml of MTMS (methyltrimethoxysilane) was added thereto, while the solution was stirred and cooled in an ice bath. The hydrolysis reaction was continued for 5 minutes while the solution was stirred.

Then, the pair of flat plates was placed in parallel with each other; spacers E were held between them, forming a space F having a suitable thickness; and the composite was fixed as it was, forming a template, which was placed in a container. The raw material solution was poured into the container containing the composite, until the flat plate is immersed completely in the raw material solution, allowing the gel to penetrate into the template (i.e., into the space between flat plates); and then, the container was sealed and placed in a thermostat bath at 40° C., allowing the solution to gelate. After gelation, the mixture was further aged additionally for approximately 24 hours, to complete the sol-gel reaction. The treatment formed a wet gel having MTMS-derived and methyl-group-containing silanol groups interconnected to each other in the space F and hardened to give three dimensional network structure in contact with the surface of the two flat plates.

The container was unlocked; the solvent was removed by vaporization; and the glass plate C was separated from the pair of flat plates. The glass plate C was separated and removed easily without additional processing because of the PTFE tape D present as bonded to the glass plate C.

Thus in these steps, it was possible to prepare a substrate of pure Al plate A having a surface SiO₂ film and additionally a methyl group-containing porous silica film G as an adhesion layer. The thickness of the porous film G was approximately 90 μm; there was observed a shrinkage in volume of approximately 10% during vaporization and removal of the solvent, but there was no cracking or separation of the film; and thus. A porous dielectric substrate having a relatively thicker, uniform continuous skin film was prepared on the surface.

FIG. 2 is a micrograph of the cross-sectional area of the surface side of the porous dielectric substrate obtained by SEM (scanning electron microscope) (magnification: 3,000 times, in the Figure, the distance between the right and left ends of 11 white circles in the bottom right micrograph is 10 μm, i.e., the distance between adjacent white circles is 1 μm). As apparent from the Figure, the porous dielectric substrate has a porous phase in three-dimensional network structure inside and a continuous skin layer different from the porous structure having a thickness of hundreds of nm as the outmost layer.

In industrial application of the porous dielectric substrate, a thin-film electronic circuit, for example, is formed on the surface of the substrate for example by sputtering; presence of such a continuous skin layer formed on the surface of the porous structure is extremely important in the process. That is, presence of the continuous surface skin layer makes the wiring formed thereon continuous and smooth and is effective in reducing the resistance of the wiring. The surface smoothness is particularly important, because electrons flow only on the surface of an electrocal conductor (metal wiring).

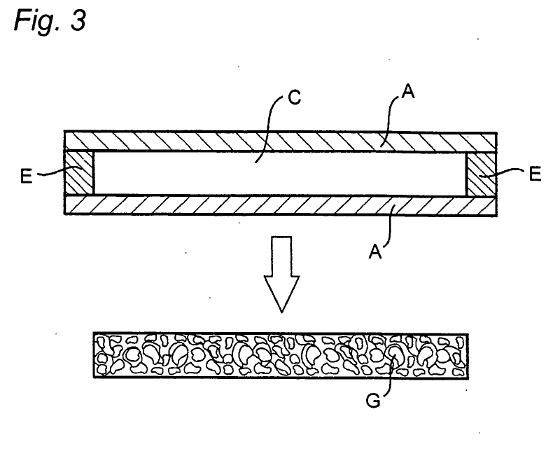

FIG. 3 is a schematic cross-sectional view illustrating the production process for a porous substrate in another embodiment of the present invention, in which a pair of glass plates surface-finished with fluorine is used as a pair of flat plates, i.e., the frame for forming a porous substrate. The fluorine-finishing agent used was “Optool DSX” (trade name, manufactured by Daikin Industries, Ltd). A porous gel was prepared in a similar manner to the Example above, by forming a parallel space C between two glass plates facing each other with PTFE spacers E, forming a wet gel by allowing the raw material solution above to react in sol-gel reaction therein, and removing the solvent by drying.

The glass plate surface-treated with the fluorine-finishing agent, which does not bond to the porous skeleton, can be separated and removed easily from the hardened porous gel. Thus, separation and removal of the two Al plates A from both faces gives a single-layered porous silica film G constituting a dielectric substrate.

The porous film G has a surface skin layer on both top and bottom surfaces, and thus, it is possible to form a circuit or a continuous metal film on the top or bottom face, for example, by vapor deposition.

What is claimed is:

1. A method for producing a porous substrate, comprising:
forming a wet gel having a three-dimensional-network skeletal solid phase and a fluid phase rich in solvent that are separated from each other in a space between a pair of flat plates by sol-gel reaction,
removing the solvent in the wet gel by drying, and removing at least one flat plate of the pair of flat plates.

2. The production method according to claim 1, wherein the wet gel is enclosed in the space formed by the pair of flat plates in contact with surfaces facing each other between the pair of flat plates.

3. The production method according to claim 1, wherein at least part of the flat plate removed is constituted by a plate that is easily separable from the surface of the skeletal solid phase formed on the surface of the flat plate.

4. The production method according to claim 1, wherein at least part of the face in contact with the wet gel of at least one of the pair of flat plates is constituted by a metal plate or a plate having a metal layer on its surface.

5. The production method according to claim 4, wherein the metal plate or the plate having a metal layer on its surface has a thin layer of a mainly silicon-containing material formed thereon.

6. The production method according to claim 1, wherein the three-dimensional-network skeletal solid phase is formed by sol-gel reaction with a mixed solution containing at least a metal alkoxide and water and additionally one or both of a catalyst and a solvent.

7. The production method according to claim 6, wherein the metal alkoxide used is a methyl group-containing silicon alkoxide.

8. The production method according to claim 1, wherein the skeletal solid phase contains silica as a principal component.

9. The production method according to claim 3, wherein the surface of the plate that is easily separable is a hydrophobic surface containing carbon or a hydrocarbon or a fluororesin as a principal component.

10. The production method according to claim 3, wherein the surface of the plate that is easily separable is at least one metal selected from Al, Cu and noble metals as a principal component.

11. A porous substrate produced by sol-gel reaction, comprising;
a three-dimensional-network skeletal solid phase inside the substrate, and
a skin layer same in quality as the skeletal solid phase formed on at least one surface of the substrate.

12. The porous substrate according to claim 11, wherein a wet gel is formed in a space between a pair of flat plates by sol-gel reaction so that at least part of the wet gel is brought into contact with each surface facing each other between the pair of flat plates, at least one flat plate of the pair of flat plates is removed before or after drying of the wet gel, and thereby the skin layer is formed on the surface side of the wet gel in contact with the removed plate.

13. The porous substrate according to claim 11, wherein the total thickness of the skeletal layer and the skin layer is within the range between 10 μm and 1,000 μm.

14. The porous substrate according to claim 11, wherein the thickness of the skin layer is within the range between 10 nm and 1 μm.

15. The porous substrate according to claim 11, wherein the skeletal solid phase contains silica as a principal component and the porous substrate is used as a material for circuit boards used in a high frequency region of 10 GHz or more.
